(19) United States
(12) Patent Application Publication
(10) Pub. No.: US 2011/0267313 A1
(43) Pub. Date: Nov. 3, 2011

(54) OPTICAL TOUCH DISPLAY SYSTEM AND METHOD THEREOF

(75) Inventor: CHUEH-PIN KO, TAIPEI (TW)

(73) Assignee: ACER INCORPORATED, TAIPEI COUNTY (TW)

(21) Appl. No.: 12/769,638

(22) Filed: Apr. 28, 2010

(51) Int. Cl. G06F 3/042

(52) U.S. Cl. 345/175

(57) ABSTRACT

An optical touch display system and method thereof are disclosed. The optical touch display system comprises a displayer, a processor, a light emitting control module and a light sensing module. The displayer comprises a display panel and a backlight module capable of emitting a visual light and a non-visual light. The processor receives multiple frames and controls the displayer to show these frames. The light emitting control module, based on a timing interlace mode or a frame arrangement mode, controls the backlight module to emit the visual light or the non-visual light selectively. The light sensing module receives a non-visual signal on surface of the displayer, and the processor determines location of an object above the surface according to the non-visual signal.

### TECHNICAL FIELD

The present invention relates generally to an optical touch display method thereof, more particularly, related to a optical touch technology of controlling backlight to selectively emit visual light or non-visual light.

### BACKGROUND

Currently, the touchable user interface is more and more popular. The small size touch screens, such as the touch screen of handheld, are usually implemented by resistive touch scheme or capacitive touch scheme. Optical touch scheme is usually applied in larger size touch screens. In optical touch system, at least two infra-red light sources and at least two cameras are respectively arranged on the top-left and top-right of displayer, and a reflector is arranged in the right edge, left edge and bottom edge of displayer. The reflector is use to reflect the infra-red light emitted from infra-red light sources to the camera which captures the infra-red images above the surface of displayer. When an object is close to the surface of displayer, at least one black area will appear in the infra-red images due to the block of reflected infra-red light by the object. Therefore, the coordinate of the object above surface of the displayer can be calculated based on the location of black area in the infra-red images.

Besides, in other optical touch display scheme the infra-red light source is embedded in the backlight module of the displayer, so that the reflector is not necessarily required and the thickness of displayer can be reduced. While shown an image, the optical characteristics of pixels of the display panel are different, however, the infra-red light must be emitted through the display panel for touch detection, and the image shown on the display panel may interfere the emitting of the infra-red light, and it causes the decrease of touch sensitivity.

### SUMMARY OF THE INVENTION

Therefore, an object of the present invention is to provide an optical touch display system and method thereof, so as to improve touch sensitivity by reduce effect caused by the shown image on display panel.

The object of the present invention can be achieved by providing a an optical touch display system which comprises a displayer, a processor, a light emitting control module and a light sensing module. The displayer comprises a display panel and a backlight module capable of emitting a visual light and a non-visual light. The processor receives multiple frames and controls the displayer to show these frames. The light emitting control module, based on a timing interlace mode or a frame arrangement mode, controls the backlight module to emit the visual light or the non-visual light selectively. The light sensing module receives a non-visual signal on surface of the displayer, and the processor determines location of an object above the surface according to the non-visual signal.

Preferably, said light sensing module is located on edge of said displayer, or an area inside said displayer; said area is corresponding to said display panel.

Preferably, said light emitting control module, in said timing interlace mode, controls said backlight module to emit said visual light while said displayer shows one of said frames.

Preferably, said light emitting control module, in said timing interlace mode, controls said backlight module to emit non-visual light while said displayer does not show said frames.

Preferably, the interlace pattern of first time slots where said backlight module emits said visual light, and second time slots where said backlight module emits said non-visual light, is a fix ratio pattern, periodic varied pattern or a event triggered pattern.

Preferably, said light emitting control module, in said frame arrangement mode, controls a first portion of said backlight module to emit said visual light and a second portion of said backlight module to emit said non-visual light.

Preferably, said light emitting control module changes the arrangement of said first portion and said second portion periodically.

The object of the present invention can be achieved by providing an optical touch display method applied to a displayer comprising a display panel and a backlight module. The backlight module is capable of emitting a visual light and a non-visual light. The optical touch display method comprises the steps of receiving multiple frames and controlling said displayer to show said multiple frames; controlling said backlight module, based on a timing interlace mode or a frame arrangement mode, to emit said visual light or said non-visual light selectively; using a light sensing module to receive a non-visual signal above the surface of said displayer; determining a location of an object on said surface according to said non-visual signal.

Preferably, the optical touch display method further comprises a step of controlling said backlight module, in said timing interlace mode, to emit said visual light while said displayer shows one of said frames.

Preferably, the optical touch display method further comprises a step of controlling said backlight module, in said timing interlace mode, to emit non-visual light while said displayer does not show said frames.

Preferably, the interlace pattern of first time slots where said backlight module emits said visual light, and second time slots where said backlight module emits said non-visual light, is a fix ratio pattern, periodic varied pattern or a event triggered pattern.

Preferably, the optical touch display method further comprises a step of controlling a first portion of said backlight module, in said frame arrangement mode, to emit said visual light and a second portion of said backlight module to emit said non-visual light.

Preferably, the optical touch display method further comprises a step of changing the arrangement of said first portion and said second portion periodically.

The object of the present invention can be achieved by providing an optical touch display system which comprises a processor, a displayer, a light emitting control module and a light emitting control module. The processor receives multiple frames, and the displayer emits a visual light and a non-visual light to display the multiple frames. The light emitting control module, based on a timing interlace mode or a frame arrangement mode, is capable of controlling said displayer to emit said visual light or said non-visual light selectively. The light sensing module receives a non-visual signal above the surface of said displayer and the processor determines a location of an object on said surface according to said non-visual signal.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 illustrates a block diagram of first embodiment of an optical touch display system in accordance with the present invention;

FIG. 2 illustrates examples of timing interlace mode applied in the optical touch display system in accordance with the present invention;

FIG. 3 illustrates examples of frame arrangement mode applied in the optical touch display system in accordance with the present invention;

FIG. 4 illustrates a schematic view of second embodiment of an optical touch display system in accordance with the present invention;

FIG. 5 illustrates a block diagram of second embodiment of an optical touch display system in accordance with the present invention;

FIG. 6 illustrates a flow chart of first embodiment of an optical touch display method in accordance with the present invention; and

FIG. 7 illustrates a flow chart of second embodiment of an optical touch display method in accordance with the present invention.

### DETAILED DESCRIPTION OF THE PREFERRED EMBODIMENTS

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below. It should also be noted that the drawings are in simplified form and are not to precise scale.

In reference to the disclosure herein, for purposes of convenience and clarity only, directional terms, such as, top, bottom, left, right, up, down, over, above, below, beneath, rear, front, distal, and proximal are used with respect to the accompanying drawings. Such directional terms should not be construed to limit the scope of the invention in any manner.

In one preferred aspect of the inventive subject matter, the projection system provides a color visual output, wherein the color vividness and performance of the visual output is enhanced. The contemplated color visual output can include still images and video images.

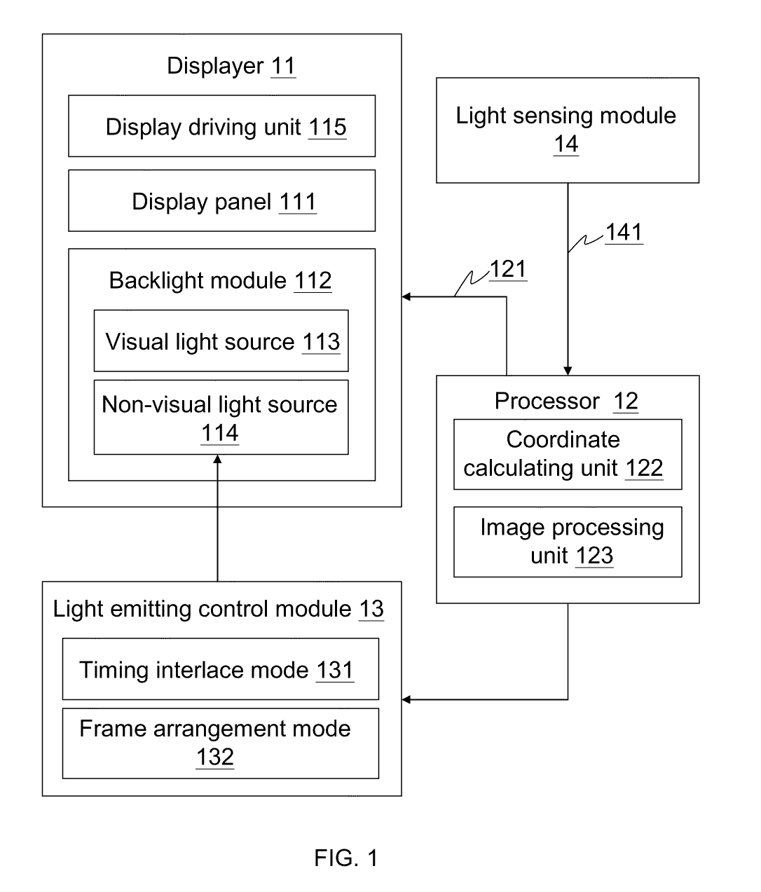

FIG. 1 illustrates a block diagram of first embodiment of an optical touch display system in accordance with the present invention. The optical touch display system 1 comprises a displayer 11, a processor 12, a light emitting control module 13 and a light sensing module 14. The displayer 11 comprises a display panel 111 and a backlight module 112 having a visual light source 113 and a non-visual light source 114. The visual light source 113 is capable of emitting a visual light for display, and the non-visual light source 114 is capable of emitting a non-visual light, such as infra-red light, for touch detection. Preferably, the visual light source 113 is one white light source, or a light source having a red led, a green led and a blue led; the non-visual light source 114 is an infra-red led, or a red led of which spectrum covers infra-red spectrum. Preferably, the display panel 111 is a liquid crystal display panel. The light sensing module can be a camera capable of capturing an infra-red image.

The processor 12 comprises an image processing unit 123 and a coordinate calculating unit 122. Preferably, the function of image processing unit 123 can include image digitization, image decompression or format conversion. Multiple frames 121 transmitted to the processor 12 is processed by the image processing unit 123, and the processed frame 121 is then shown on the displayer 11. In embodiment, the processed frame 121 is transmitted to and stored in the buffer of the display driving unit 115, and the processor 12 then control the display driving unit 115 to drive the display panel 111 to show the processed frame 121. It is noted that the technology of panel driving is well known for person having ordinarily knowledge in the art, so we do not explain it in detail again.

The light emitting control module 13 is operable to control the visual light source 113 to emit visual light through the display panel 111 to outside of the displayer 11, so that user can view the frame 121 shown on the display panel 111. The light emitting control module 13 is also operable to control the non-visual light source 114 to emit non-visual light through the display panel 111 to outside of the displayer 11, and the light sensing module 14 can detect a non-visual signal 141 on surface of the displayer 11, and coordinate calculating unit 122 of the processor 12 can determine location of an object above surface of the displayer 11 according to the non-visual signal 141. Preferably, the light sensing module 14 can be located on edge of said displayer, or an area inside the displayer which corresponding to said display panel. The non-visual signal 141 is a one-dimensional infer-red image or a two-dimensional infer-red image.

The sensitivity of touch detection may be reduced due to the decayed non-visual light being interfered by the frame shown on display panel 111. To solve the interference effect caused by the shown frame, the light emitting control module 13 according to the timing interlace mode 131 or the frame arrangement mode 132 controls the backlight modules 112 to selectively emit the visual light or the non-visual light, so as to reduce above-mentioned interference. In timing interlace mode 131, the first time slots where said backlight module emits said visual light, and second time slots where said backlight module emits said non-visual light, are arranged interlacedly. The light emitting control module 13 controls the backlight module 112 to emit the visual light while the display panel 111 shows one of the frames 121, and controls the backlight module 112 to emit the non-visual light while said display panel 111 does not show the frames 121. While not displaying the frames 121, the optical character of pixels of the display panel 111 are substantial similar, so that the interference for the non-visual light can be reduced efficiently. The backlight module emitting visual light and non-visual light interlacedly can keep the touch sensitivity of the optical touch display system 1 without decaying the user viewing experience.

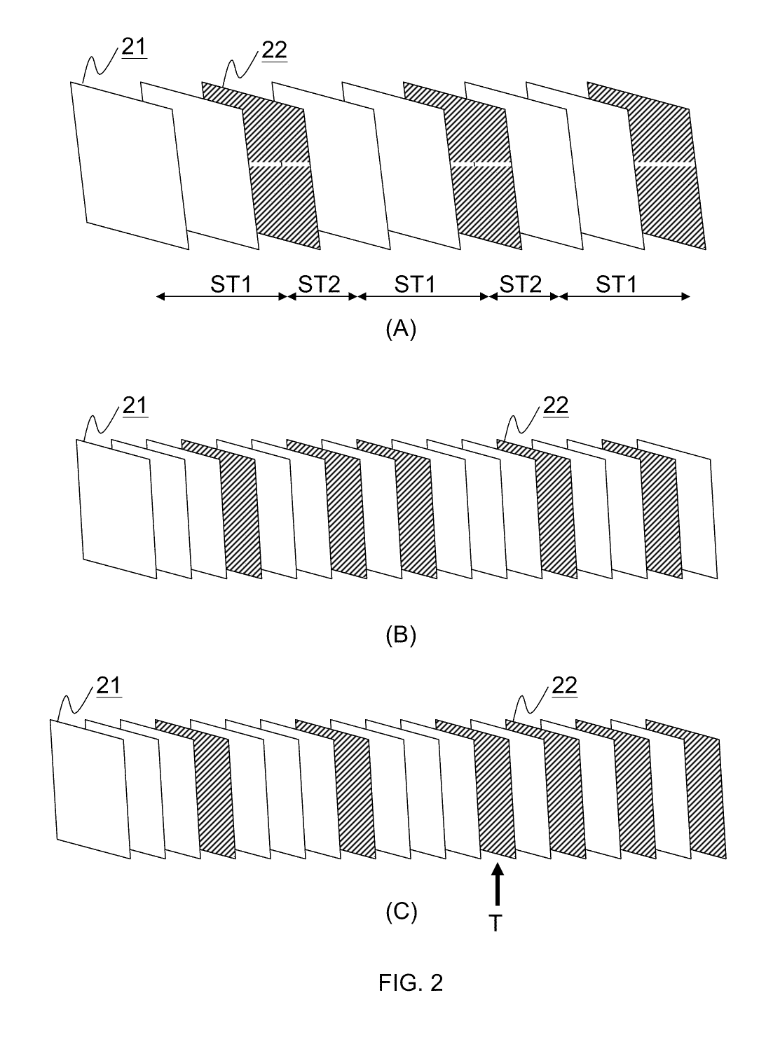

Preferably, interlace pattern of time slot ST1 and ST2 can be is a fix ratio pattern, periodic varied pattern or an event triggered pattern. FIG. 2 illustrates examples of timing interlace mode applied in the optical touch display system in accordance with the present invention. The white block 21 represents the area of frame 121, where the display panel 111 shows the image of frame 121 and the backlight module 112 emits visual light. The block 22 drawn with oblique lines represents the area of frame 121, where the display panel 111 shows nothing and the backlight module 112 emits the non-visual light. The example (A) represents the time slots ST1 and ST2 arranged by the fix ratio pattern, where the time slots ST1 and ST2 are arranged in fix ratio, such as 2:1.

When the time slots ST1 and ST2 arranged by the periodic varied pattern, the allocation time slots ST1 and ST2 are changed periodically. The example (B) represents the period of allocation of ST1 and ST2 is 3:1:2:1:1:1. When the time slots ST1 and ST2 arranged by the event triggered pattern, the allocation of ST1 and ST2 is changed while the processor 12 determines that an object exists above the surface of displayer 11. For example, the light emitting control module 13 can control the backlight module to emit non-visual light more frequently, so as to improve the touch sensitivity. The example (C) represents that the time slots ST1 and ST2 are allocated with a ratio 3:1 initially, and the ratio is changed to 1:1 for more frequently emitting of non-visual light after an object is determined to exist above the surface of displayer 11 at time point T.

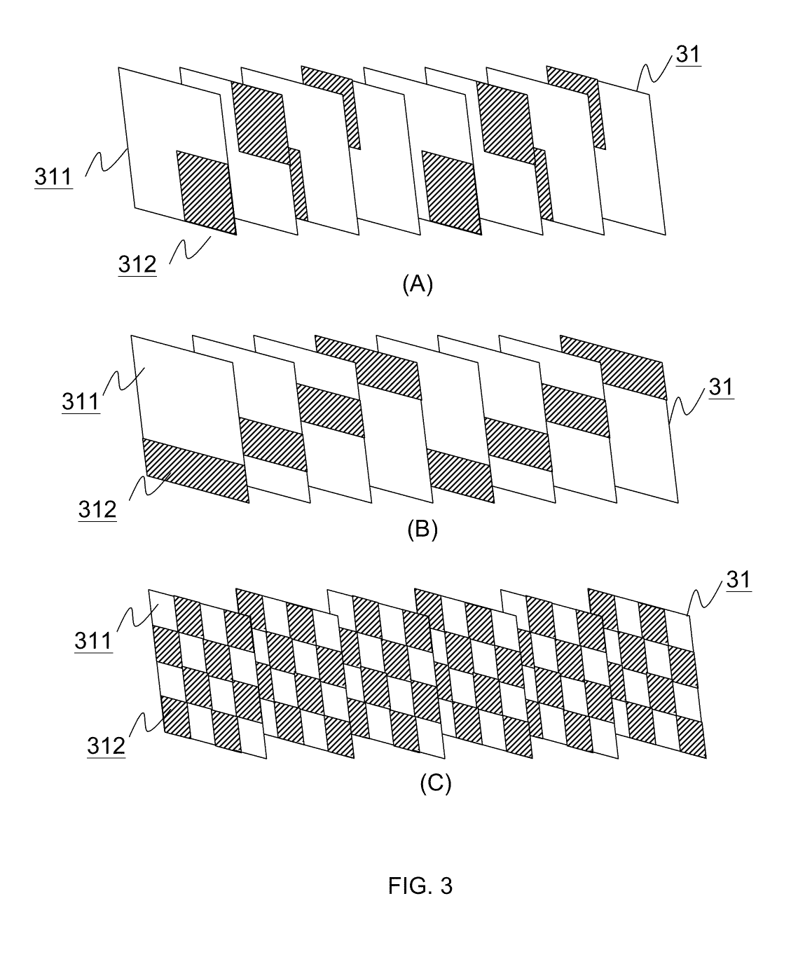

In the frame arrangement mode 132, the light emitting control module 13 controls a first portion of the backlight module 112 to emit the visual light and a second portion of the backlight module 112 to emit the non-visual light. FIG. 3 illustrates examples of frame arrangement mode applied in the optical touch display system in accordance with the present invention. The block 31 represents a whole area of a frame 121. The portion 312 drawn with oblique lines represents an area where the display panel 111 shows nothing and the backlight module 112 emits the non-visual light; the rest portion 311 represents an area where the display panel 111 shows image of frame and the backlight module 112 emits the visual light. In FIG. 3, the example (A) represents that the area frame 121 are divided into four portions, top-left portion, bottom-left portion, top-right portion and bottom-right portion. The light emitting control module 13 controls the backlight module 113 to periodically emit non-visual light in one of portions in sequence at different time slot. The example (B) represents that the area frame 121 are vertically divided into four portions, and the light emitting control module 13 controls the backlight module 113 to periodically emit non-visual light in one of portions in sequence at different time slot. The example (C) represents that the area frame 121 are divided into multiple portions by a chessboard pattern, and these portions are grouped into two portion groups. The light emitting control module 13 controls the backlight module 113 to periodically emit non-visual light in one of portion groups in sequence at different time slot. Preferably, division unit of the area frame 121 can be one pixel, or a pixel line. The timing interlace mode and the frame arrangement mode, if necessary, can be mixed to apply in the light emitting control module 13.

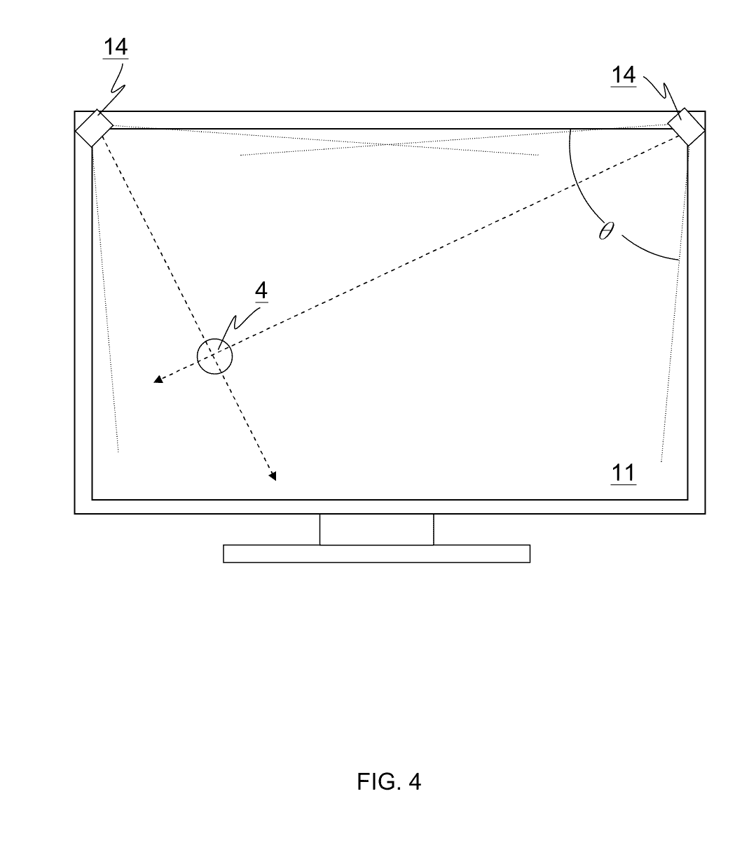

FIG. 4 illustrates a schematic view of second embodiment of an optical touch display system in accordance with the present invention. An object 4 is placed above the displayer. The two light sensing modules 14 having view angle θ are arranged respectively on top-left coiner and top-right corner of displayer 11, in order to capture the image of the object 4 above the surface of displayer 11.

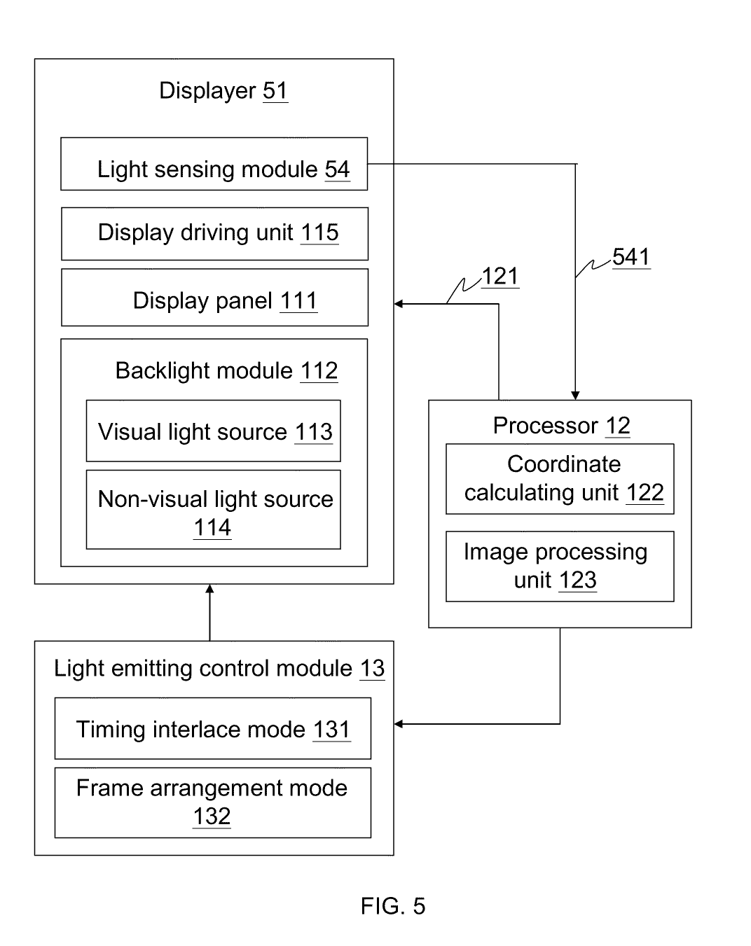

FIG. 5 illustrates a block diagram of second embodiment of an optical touch display system in accordance with the present invention. The difference between the first embodiment and second embodiment is that, in second embodiment, the light sensing module 54 is arranged inside of the displayer 51 to receive the non-visual light reflected from the object located above the surface of displayer. The light sensing module 54 then transmits a non-visual signal 541 to processor 12 for further coordinate calculation.

Preferably, the display panel 111 and backlight 112 can be implemented by a self-emitting display panel, such as OLED panel. The operations of timing interlace mode and frame arrangement mode in self-emitting display panel are similar with above-mentioned embodiments, so that we do not describe in detail.

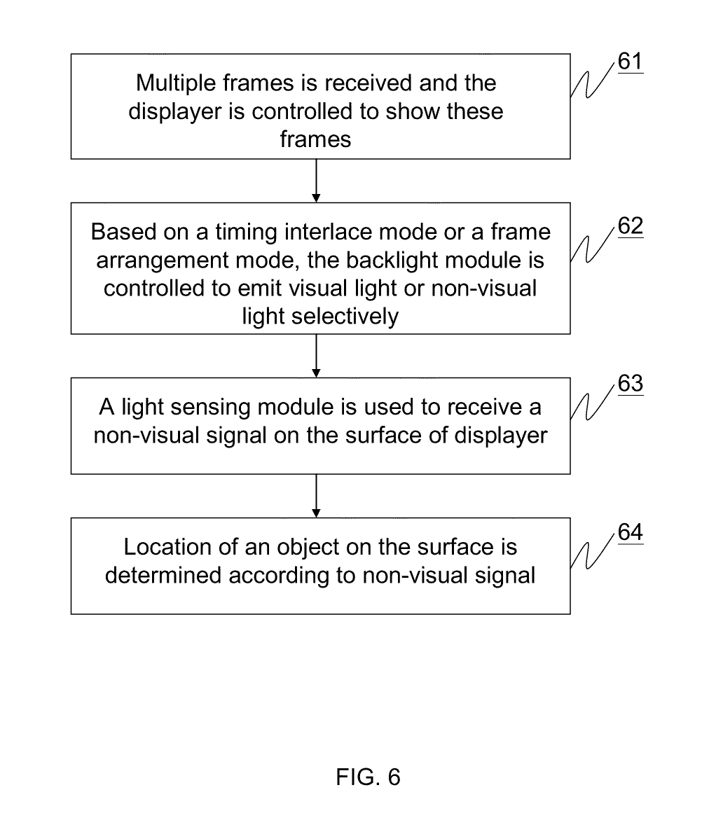

FIG. 6 illustrates a flow chart of first embodiment of an optical touch display method in accordance with the present invention. This embodiment comprises the following steps. In step 61, multiple frames are received and the displayer is controlled to show the multiple frames. In step 62, according to a timing interlace mode or a frame arrangement mode the backlight module is controlled to emit the visual light or the non-visual light selectively. In step 63 a light sensing module is used to receive a non-visual signal above the surface of the displayer. In step 64 the location of an object above the surface is determined according to the non-visual signal. In the timing interlace mode, the method preferably further comprises the sub-steps of controlling the backlight module to emit the visual light while the displayer shows one of the frames; controlling the backlight module to emit non-visual light while the displayer does not show the frames, as shown in FIG. 2. Preferably, the interlace pattern of first time slots where the backlight module emits said visual light, and second time slots where said backlight module emits said non-visual light, can be a fix ratio pattern, periodic varied pattern or a event triggered pattern. In said frame arrangement mode, the method preferably further comprises the sub-steps of controlling a first portion of said backlight module to emit said visual light and a second portion of said backlight module to emit said non-visual light, as shown in FIG. 3. Preferably, the arrangement of said first portion and said second portion is changed periodically.

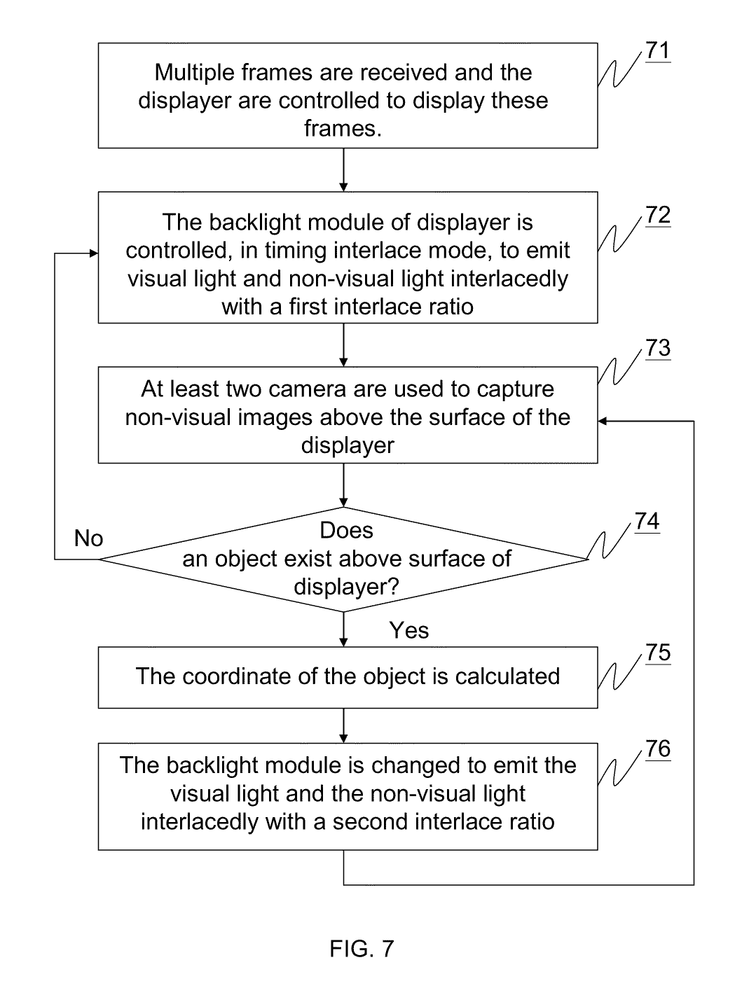

FIG. 7 illustrates a flow chart of second embodiment of an optical touch display method in accordance with the present invention. This embodiment adopts the event triggered pattern and comprises the following steps. In step 71 multiple frames are received and the displayer is controlled to display these frames. In step 72 the backlight module of the displayer is controlled, in timing interlace mode, to emit the visual light and the non-visual light interlacedly with a first interlace ratio. In step 73 at least two camera are used to capture non-visual images above the surface of the displayer. In step 74 it is determined whether an object exists above the surface of displayer. If no object exists, then the flow returns to step 72. If it is determined that at least object exists above the surface of displayer, the coordinate of the object is calculated in step 75. The backlight module is changed to emit the visual light and the non-visual light interlacedly with a second interlace ratio in step 76, and the flow then returns to step 73. As the example (C) shown in FIG. 2, before the time point T where the object is detected, the first interlace ratio is 3:1, and the second interlace ratio is 1:1 after time point T.

Thus, specific embodiments and applications of optical touch display system and method thereof have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. An optical touch display system, comprising:
a displayer including a display panel and a backlight module which emits a visual light and a non-visual light;
a processor receiving multiple frames and capable of controlling said displayer to show said multiple frames;
a light emitting control module, based on a timing interlace mode or a frame arrangement mode, capable of controlling said backlight module to emit said visual light or said non-visual light selectively; and
a light sensing module receiving a non-visual signal above the surface of said displayer;
wherein said processor determines a location of an object on said surface according to said non-visual signal.

2. The optical touch display system of claim 1, wherein said light sensing module is located on edge of said displayer, or an area inside said displayer; said area is corresponding to said display panel.

3. The optical touch display system of claim 1, wherein said light emitting control module, in said timing interlace mode, controls said backlight module to emit said visual light while said displayer shows one of said frames.

4. The optical touch display system of claim 3, wherein said light emitting control module, in said timing interlace mode, controls said backlight module to emit said non-visual light while said displayer does not show said frames.

5. The optical touch display system of claim 4, wherein a interlace pattern of first time slots where said backlight module emits said visual light, and second time slots where said backlight module emits said non-visual light, is a fix ratio pattern, periodic varied pattern or a event triggered pattern.

6. The optical touch display system of claim 1, wherein said light emitting control module, in said frame arrangement mode, controls a first portion of said backlight module to emit said visual light and a second portion of said backlight module to emit said non-visual light.

7. The optical touch display system of claim 6, wherein said light emitting control module changes the arrangement of said first portion and said second portion periodically.

8. An optical touch display method, applied to a displayer comprising a display panel and a backlight module, and said backlight module capable of emitting a visual light and a non-visual light, said optical touch display method comprising:
receiving multiple frames and controlling said displayer to show said multiple frames;
based on a timing interlace mode or a frame arrangement mode, controlling said backlight module to emit said visual light or said non-visual light selectively;
using a light sensing module to receive a non-visual signal above the surface of said displayer; and
determining a location of an object on said surface according to said non-visual signal.

9. The optical touch display method of claim 8, further comprising:
controlling said backlight module, in said timing interlace mode, to emit said visual light while said displayer shows one of said frames.

10. The optical touch display method of claim 9, further comprising:
controlling said backlight module, in said timing interlace mode, to emit non-visual light while said displayer does not show said frames.

11. The optical touch display method of claim 10, wherein a interlace pattern of first time slots where said backlight module emits said visual light, and second time slots where said backlight module emits said non-visual light, is a fix ratio pattern, periodic varied pattern or a event triggered pattern.

12. The optical touch display method of claim 8, further comprising:
controlling a first portion of said backlight module, in said frame arrangement mode, to emit said visual light and a second portion of said backlight module to emit said non-visual light.

13. The optical touch display method of claim 12, further comprising:
changing the arrangement of said first portion and said second portion periodically.

14. An optical touch display system, comprising:
a processor receiving multiple frames;
a displayer emitting a visual light and a non-visual light to display said multiple frames;
a light emitting control module, based on a timing interlace mode or a frame arrangement mode, capable of controlling said displayer to emit said visual light or said non-visual light selectively; and
a light sensing module receiving a non-visual signal above the surface of said displayer;
wherein said processor determines a location of an object on said surface according to said non-visual signal.
